(19) United States
(12) Patent Application Publication
(10) Pub. No.: US 2009/0292841 A1
(43) Pub. Date: Nov. 26, 2009

(54) INTERFACE AND METHOD FOR TRANSMITTING BITS TO A TWO-WIRE BUS APPLYING A LIN PROTOCOL

(75) Inventors: Marcus Weser, Kaarst (DE); Matthias Muth, Stelle (DE); Thomas Suermann, Hamberg (DE)

Correspondence Address: NXP, B.V.;NXP INTELLECTUAL PROPERTY & LICENSING, M/S41-SJ, 1109 MCKAY DRIVE, SAN JOSE, CA, 95131, US

(73) Assignee: KONINKLIJKE PHILIPS ELECTRONICS N.V., Eindhoven (NL)

(21) Appl. No.: 11/720,747

(22) PCT Filed: Nov. 30, 2005
(86) PCT No.: PCT/IB2005/053972

§ 371 Date: Jul. 31, 2009

(30) Foreign Application Priority Data
Dec. 1, 2004 (EP) 04106198.7

(51) Int. Cl. G06F 13/14; G06F 13/42

(52) U.S. Cl. 710/106; 710/305

(57) ABSTRACT

Networks on board of vehicles have to provide a rapid data throughput, and be still inexpensive and electromagnetically compatible (EMC). An interface (100, 110) comprising at least one physical layer and a method for transmitting at least one bit to at least one two-wire bus (10, 12), in particular to at least one C[ontroller]A[rea]N[etwork] bus, for example based on the ISO 11898 standard, are disclosed. It is proposed that the transmission takes place on the basis of the L[ocal]I[nterconnect]N[etwork] protocol. The same technology can be implanted in a device or a circuit arrangement.

The present invention relates to an interface comprising at least one physical layer and to a method for transmitting at least one bit to at least one two-wire bus, in particular to at least one C[ontroller]A[rea]N[etwork] bus, for example based on the ISO 11898 standard.

In throttle valve applications and/or gas pedal applications, as described for example in the document U.S. Pat. No. 6,672,281 B1 or on the Internet site http://www.auto-solve.com/etc.htm, use is currently made primarily of potentiometers. In this case, the throttle valve sensor which is used is a variable resistor which, depending on the angle of the throttle valve, transmits a variable signal to correct the injection quantity, for example when speeding up or slowing down.

Such potentiometers are at present being gradually replaced by contactless angle sensors. In this case, use is made primarily of Hall sensors or A[nisotropic]M[agneto]-R[esistive] sensors. Such sensors are described for example in the document DE 101 54 154 A1 or in the document US 2002/0149358 A1.

The angle information is transmitted in an analog fashion, that is to say the angle signal is a linear function of the output voltage Vout of the sensors. This output voltage Vout is typically around 2.5 percent to about 95 percent of the supply voltage, and the projected angle range is up to 120 degrees. In this case, small angles, for example angle ranges from zero degrees to about twenty degrees, are of particular interest for reasons of engine control in throttle valve applications.

One particular disadvantage of analog transmission is the small signal voltages at these small angles. Typical interference voltages of for example fifty millivolts, as occur for example in the engine space of cars for reasons of E[lectro]M[agnetic]C[ompatibility], therefore lie fully within the signal range and lead to interference.

When digital interfaces are used as an alternative for angle sensors, the following disadvantages are obtained:
the P[ulse]W[idth]M[odulation] protocol, which is used for example in the case of Hall sensors, is too slow;
the S[erial]P[eripheral]I[nterface] principle is optimized only for short distances; in the case of a cable length of two meters for example, problems arise in terms of electromagnetic compatibility and for this reason screened lines have to be used. Another disadvantage in the known PWM and SPI solutions is that usually just one sensor per PWM interface is possible or a large number of lines are used in the case of SPI.

Use may alternatively be made of the various bus systems used in the motor vehicle, such as the C[ontroller]A[rea]N[etwork] and L[ocal]I[nterconnect]N[etwork] (cf. C. Gabriel and H. Horia: “Integrating Sensor Devices in a LIN bus network”, 26th ISSE 2003, pages 150 to 153, or R. Bannatyne and K. Klein: “Chassis Control System to Interface Sensors and Electronic Control Units”, Motorola Inc. 1999, pages 137 to 144). However, CAN is too expensive and over-specified for simple sensor applications, whereas LIN does not provide the necessary data throughput for these sensor applications.

For digital data transmission in a network which can be supplied with a DC voltage of 12 Volt to 42 Volt by a vehicle battery, the company Yamar offers a D[irect]C[urrent] bus which is compatible with protocols relating to CAN, LIN or J1850 (cf. http://www.yamar.com/). However, the EMC properties of this D[irect]C[urrent] bus are regarded as requiring improvement.

There is therefore a need, especially in respect of angle sensors in the motor vehicle sector, to provide a novel sensor interface, in particular a digital sensor interface, which on the one hand is cost-effective and EMC-safe and on the other hand permits a rapid data throughput.

Based on the abovementioned disadvantages and deficiencies and with acknowledgement of the outlined prior art, it is an object of the present invention to further develop an interface of the aforementioned type and also a method of the aforementioned type in such a way that particularly good EMC properties and a high transmission rate, for example a data transmission rate of one megabit per second, are provided while being cost-effective to manufacture.

This object is achieved by an interface having the features specified in claim 1 and by a method having the features specified in claim 8. Advantageous embodiments and expedient developments of the present invention are characterized in the respective dependent claims.

By cleverly combining the physical layer, in particular the C[ontroller]A[rea]N[etwork] physical layer, and the L[ocal]I[nterconnect]N[etwork] protocol, it is possible to combine the cost advantage of the LIN protocol with the EMC properties of the physical layer in such a way that a cost-effective and EMC-legitimate interface, in particular sensor interface, is ultimately produced, for example for motor vehicle applications. For example, an angle sensor with a CAN physical layer which operates with a LIN protocol can be used in particular for electronic control systems in the vehicle sector.

Transmission of the cost-effective LIN protocol via an EMC-optimal CAN physical layer allows the connection of rapid sensors via the bus system, for example in the vehicle.

A so-called “physical layer” is a bit transmission layer or a physical level which is responsible for the bit transmission of the data. The physical layer (=first layer in the O[pen]S[ystems]I[nterconnection] reference model) usually defines the electronic, functional and procedural parameters and aids for the physical connection between units on a network. Such a physical layer may be used, for example in a vehicle, for data transmissions of up to one Megabaud (=Megabit per second).

The two-wire bus which is used according to the invention, in particular a so-called “High Speed CAN Physical Layer”, is characterized by particularly good EMC properties which are achieved by virtue of a differential transmission via at least two bus lines. By way of example, according to one advantageous embodiment of the present invention, the physical layer is designed for differential transmission of the bits
via at least a first transmission line, in particular via the C[ontroller]A[rea]-N[etwork]H[igh] line, and
via at least a second transmission line, in particular via the C[ontroller]-A[rea]N[etwork]L[ow] line.

By contrast, the LIN bus system conventionally makes use of a so-called single-wire physical layer, which for reasons of electromagnetic compatibility can be used only for up to about twenty kilobits per second and thus is too slow for example for sensor applications in a vehicle.

The advantage of LIN lies in the simple bus protocol which can be converted into software on standard microcontrollers using a serial/parallel converter, for example the U[niversal]A [synchronous] R[eceiver]T[ransmitter]/S[erial]C[ommunication]I [nterface]. This UART/SCI interface is usually available in standard microcontrollers. By contrast, a CAN protocol controller is usually not available in conventional microcontrollers, and for this reason the use of a CAN protocol controller is conventionally associated with corresponding additional costs.

The present invention also relates to a device, in particular an actuator or a sensor, for detecting and/or recording and/or forwarding at least one property and/or setting and/or information item and/or change in the property and/or setting and/or information item which can be converted into at least one bit,
comprising at least one interface of the type described above, and/or
operating in accordance with the method of the type described above.

In this case, the device may be designed as at least one contactless angle sensor, in particular as at least one A[nisotropic]M[agneto]R[esistive] sensor and/or as at least one Hall sensor. AMR angle sensors offer a special advantage since they operate inter alia with digital signal processing and therefore have a digital interface. This is particularly advantageous since there is thus no need for any signal conversion from digital to analog in the sensor and from analog to digital at a control unit.

Advantageously, such an angle sensor element may be formed at least partially of at least one ferromagnetic alloy, for example of Permalloy. Permalloy (Ni₈₀Fe₂₀) offers the advantage that it allows a high magnetic permeability with simultaneously low field strength and a low hysteresis loss. The magnetic properties of such ferromagnetic structures can be set in the desired manner by virtue of the external shape.

The present invention also relates to a circuit arrangement, in particular an integrated circuit, having
at least one transmitting/receiving unit, in particular at least one C[ontroller]A[rea]N[etwork] transceiver, which is connected to at least one device of the aforementioned type via at least one two-wire bus, in particular via at least one C[ontroller]A[rea]N[etwork] bus, for example based on the ISO 11898 standard, and
at least one microcontroller which is connected to the transmitting/receiving unit, in particular based on the S[erial]C[ommunication]I[nterface]/U[niversal]-A[synchronous]R[eceiver]T[ransmitter] standard.

Another advantageous criterion of the present invention compared to the prior art is the fact that such a circuit arrangement has optimal EMC properties and it moreover makes it possible to connect a number of devices, in particular a number of sensors or a number of actuators, to a two-wire bus. Here, use may be made of cost-effective devices since according to the invention the transmission takes place on the basis of the LIN protocol and thus no complicated protocol is required.

With regard to the advantages which can be achieved by virtue of the present invention, it should furthermore be noted that both the LIN protocol which is used according to the invention and also the CAN physical layer which is advantageously used in each case represent an accepted standard per se.

The present invention finally relates to the use of at least one interface of the aforementioned type and/or of at least one device of the aforementioned type and/or of at least one circuit arrangement of the aforementioned type and/or of a method of the aforementioned type for electronic applications in a vehicle, in particular for angle measurement, for example contactless angle measurement, for instance in throttle valve applications and/or in gas pedal applications.

In particular, the invention can be used in the motor vehicle sector, for example in connection with at least one throttle valve sensor from the company Philips and with at least one CAN physical layer.

As already mentioned above, there are various possibilities for advantageously configuring and developing the teaching of the present invention. In this respect, reference is made to the claims dependent on claim 1, claim 3, claim 5 and claim 8.

The invention will be further described with reference to examples of embodiments shown in the drawing to which, however, the invention is not restricted.

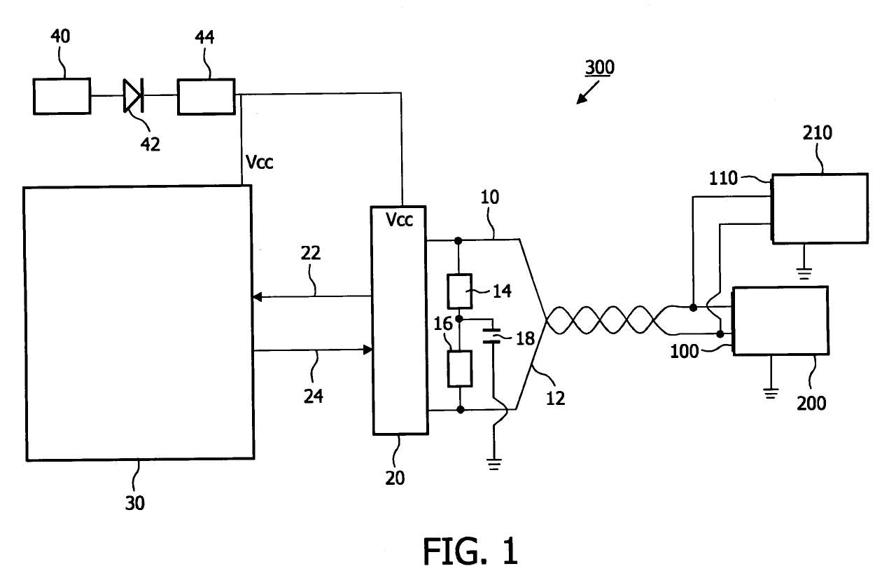

FIG. 1 schematically shows an example of embodiment of a circuit arrangement according to the present invention which operates in accordance with the method according to the invention.

The circuit arrangement 300 according to the present invention which is illustrated in FIG. 1 comprises an example of embodiment of an interface 100 according to the present invention. The interface 100 operates in accordance with the method according to the present invention and is assigned to an example of embodiment of a device 200 according to the present invention, namely to a sensor for detecting vehicle-related parameters.

The circuit arrangement 300 furthermore comprises a second interface 110 according to the present invention which likewise operates in accordance with the method according to the present invention and is assigned to a second sensor 210, namely to a detection unit for recording the environmental parameters of the motor vehicle.

The interfaces 100, 110 are both connected to one and the same two-wire bus 10, 12, namely to a so-called CAN bus, the physical layer of which is defined in accordance with DIN ISO 11898. The data bus 10, 12 has two data bus lines, namely
CANH[igh] (-->reference 10) and
CANL[ow] (-->reference 12),
   via which the bits are transmitted—optionally differentially.

In the rest state of the CAN bus, both data bus lines 10, 12 are at approximately the same potential since the two lines 10, 12 are connected to one another via two (terminal) resistances 14, 16 of for example thirty Ohms in each case. Connected between these two terminal resistances 14, 16 is a capacitor 18 which has a capacitance of for example 4.7 nanofarad, and the capacitive partial element of said capacitor which is not assigned to the terminal resistances 14, 16 is at ground, that is to say is connected to ground potential GND (i.e. is “earthed”).

When individual bits are transmitted by the sensor elements 200, 210, the potential of the data bus line CANH 10 is raised and the potential of the data bus line CANL 12 is correspondingly lowered.

In the circuit arrangement 300 shown in FIG. 1, this takes place by means of at least one driver integrated in the transceiver 20. In the example of embodiment shown in FIG. 1, this driver is arranged in the transmitting/receiving unit 20, namely in the transceiver of the type TJA1040 from the company Philips (cf. corresponding Philips Data Sheet in the version dated 14 Oct. 2003) or of comparable types such as for example TJA1050, TJA1041, etc.

This transceiver 20 receives and transmits data via the CAN bus 10, 12 by means of at least one receiver integrated in the transceiver 20 and by means of at least one transmitter integrated in the transceiver 20. The analog data received via the CANH line 10 and via the CANL line 12 are converted into digital data by the transceiver 20, and said data are forwarded to at least one RxD terminal (-->reference 22).

It is also possible according to the invention to use at least one sensor or actuator with digital signal processing and with a digital interface instead of the analog sensors 200, 210. The interface 100, 110 according to the invention can thus operate in an analog and/or digital manner. In the case of a device 200, 210 with digital signal processing and with a digital interface 100, 110, there is no need for signal conversion from digital to analog in the device 200, 210 and from analog to digital at a control unit, for example at the transceiver 20.

By means of the RxD signal coming from the RxD terminal of the transceiver 20 and transported via the RxD line 22, and by means of the TxD signal transported via the TxD line 24 and arriving at the TxD terminal of the transceiver 20, the transceiver 20 communicates with a microcontroller 30 with a S[erial]C[ommunication]I[nterface] module.

The transmission of the output signals of the transceiver 20 on the CAN bus lines 10, 12 is optimized and defined by the use of a so-called (time-out &) slope unit which is integrated in the transceiver 20, in such a way that very low electromagnetic emission occurs.

The transceiver 20 may also be switched into a standby mode, for example in order to save power. In this standby mode, the receiver and the transmitter of the transceiver 20 are switched off, and the bus lines 10, 12 are monitored by a differential low-power receiver.

For power supply purposes, the transceiver 20 and the microcontroller 30 are supplied with a supply voltage Vcc by the (car) battery 40 which has a rectifier diode 42 and a voltage regulator 44 connected downstream. The two sensors 200, 210 are connected to ground potential as reference potential, that is to say are earthed.

### LIST OF REFERENCES

100 interface, in particular interface of the device 200
110 interface, in particular interface of the second device 210
10, 12 two-wire bus, in particular C[ontroller]A[rea]N[etwork] bus, for example in accordance with ISO 11898 standard, and herein:
10 first transmission line of the two-wire bus 10, 12, in particular C[ontroller]A[rea]N[etwork]H[igh] line
12 second transmission line of the two-wire bus 10, 12, in particular C[ontroller]A[rea]N[etwork]L[ow] line
14 resistance, in particular terminal resistance assigned to the C[ontroller]A[rea]N[etwork]H[igh] line 10
16 resistance, in particular terminal resistance assigned to the C[ontroller]A[rea]N[etwork]L[ow] line 12
18 capacitive element, in particular capacitor
20 transmitting/receiving unit, in particular C[ontroller]A[rea]N[etwork] transceiver, for example of the type TJA1040 high speed CAN transceiver from the company Philips
22 receiving line (RxD)
24 transmitting line (TxD)
30 microcontroller, in particular based on the S[erial]C[ommunication]I[nterface]/U[niversal]A[synchronous]R[eceiver]T[ransmitter] standard
40 battery, in particular motor vehicle battery
42 diode or rectifier
44 voltage regulator
200 device, in particular actuator or sensor, for example first device, first actuator or first sensor
210 second device, in particular second actuator or second sensor
300 circuit arrangement, in particular integrated system
Vcc supply voltage

1-10. (canceled)

11. An interface comprising at least one physical layer for transmitting at least one bit to at least one two-wire Controller Area Network (CAN) bus characterized in that the transmission takes place on the basis of the Local Interconnect Network (LIN) protocol, the CAN bus based on the ISO 11898 standard.

12. The interface as recited in claim 1, characterized in that the physical layer is designed for differential transmission of the bits
via at least a first transmission line, in particular via a Controller Area Network High line (CANHigh), and
via at least a second transmission line, in particular via a Controller Area Network Low line (CANLow).

13. A sensor having at least one interface as recited in claim 11,
wherein the sensor detects at least one of the following: one property, a setting, or an information item, which can be converted into a least one bit;
wherein the sensor records at least one of the following: one property, a setting, or an information item, which can be converted into a least one bit;
wherein the sensor forwards at least one of the following: one property, a setting, or an information item, which can be converted into a least one bit;
wherein the sensor detects at least one of the following: a change in one property, a change in a setting, or a change in an information item, which can be converted into a least one bit;
wherein the sensor records at least one of the following: a change in one property, a change in a setting, or a change in an information item, which can be converted into a least one bit; and
wherein the sensor forwards at least one of the following: a change in one property, a change in a setting, or a change in an information item, which can be converted into a least one bit.

14. A sensor having at least one interface as recited in claim 12,
wherein the sensor detects at least one of the following: one property, a setting, or an information item, which can be converted into a least one bit;
wherein the sensor records at least one of the following: one property, a setting, or an information item, which can be converted into a least one bit;
wherein the sensor forwards at least one of the following: one property, a setting, or an information item, which can be converted into a least one bit;
wherein the sensor detects at least one of the following: a change in one property, a change in a setting, or a change in an information item, which can be converted into a least one bit;
wherein the sensor records at least one of the following: a change in one property, a change in a setting, or a change in an information item, which can be converted into a least one bit; and
wherein the sensor forwards at least one of the following: a change in one property, a change in a setting, or a change in an information item, which can be converted into a least one bit.

15. The sensor as recited in claim 13, wherein the sensor is configured as a contact-less angle sensor and includes at least one of the following: Anisotropic Magneto Resistive (AMR) sensor, Hall sensor; and
the sensor is formed, at least partially, for one or more ferromagnetic alloys.

16. A circuit arrangement having
at least one at least one CAN transceiver, which is connected to at least one sensor as recited in claim 13 via at least one two-wire bus, in particular via at least one CAN bus, and
at least one microcontroller connected to the CAN transceiver based on the Serial Communication Interface/Universal Asynchronous Receiver Transmitter (SCI/UART) Standard.

17. A circuit arrangement as claimed in claim 15, characterized in that the CAN transceiver also forwards complete messages.

18. A circuit arrangement as recited in claim 15, characterized in that the CAN transceiver has at least one memory unit for the buffer-storage of data to be transmitted or received.

19. A method for transmitting at least one bit to at least one CAN bus, the method on the ISO 11898 standard, wherein in the transmission takes place on the basis of the LIN protocol.

20. The method as recited in claim 18, wherein
the bits are transmitted and received via the CAN bus and
serial data can be converted into parallel data and vice versa in accordance with the SCI/UART standard.

21. The use of at least one interface as recited in claim 11.

22. The use of at least one sensor as recited in claim 13.

23. The use of at least one circuit arrangement as recited in claim 16.

24. The method as recited claim 19, wherein for electronic applications in a vehicle, contact-less angle measurements are implemented.

25. The method as recited in claim 23, wherein contact-less angle measurements are made in at least one of the following: in a throttle valve, on a gas pedal.
